(19) United States
(12) Patent Application Publication
(10) Pub. No.: US 2025/0085437 A1
(43) Pub. Date: Mar. 13, 2025

(54) METHOD AND DEVICE FOR L5 DIRECT ACQUISITION AND NH BIT SYNCHRONIZATION

(71) Applicant: Samsung Electronics Co., Ltd., Gyeonggi-do (KR)

(72) Inventors: Henry Dennis FALK, Long Beach, CA (US); Di ZHOU, San Jose, CA (US); Mayank AMIN, Mountain View, CA (US); Norman LO, Milpitas, CA (US); John KIOLBASA, Cedar Rapids, IA (US); Sigang QIU, Sunnyvale, CA (US)

(21) Appl. No.: 18/653,239

(22) Filed: May 2, 2024

Related U.S. Application Data
(60) Provisional application No. 63/581,854, filed on Sep. 11, 2023.

(51) Int. Cl. G01S 19/29; G01S 19/30; G01S 19/37

(52) U.S. Cl. CPC G01S 19/29; G01S 19/30; G01S 19/37

(57) ABSTRACT

A method and an apparatus are provided in which data is loaded from a memory to an input sample memory (ISM) of a user equipment (UE). The data corresponds to input from an L5 antenna of the UE. A first high-resolution correlation (HRC) engine of the UE performs coherent correlation and accumulation on the data for at least one code-frequency offset combination, to generate coherent correlation results. A second HRC engine of the UE processes the coherent correlation results by at least performing frequency widening and non-coherent accumulation to generate non-coherent correlation results indicating at least peak accumulations of correlations.

### CROSS-REFERENCE TO RELATED APPLICATION(S)

This application claims the priority benefit under 35 U.S.C. § 119(e) of U.S. Provisional Application No. 63/581,854 filed in the U.S. Patent and Trademark Office on Sep. 11, 2023, the disclosure of which is incorporated by reference in its entirety as if fully set forth herein.

### TECHNICAL FIELD

The disclosure generally relates to acquisition of global navigation satellite system (GNSS) signals. More particularly, the subject matter disclosed herein relates to direct acquisition of GNSS L5 signals.

### SUMMARY

Global positioning system (GPS) was made available for civilian use with L1 (1575.42 megahertz (MHz)) signals, to be later followed by use with L2 (1227.60 MHz) signals. Chip rates of a pseudo noise (PN) code, which is modulated onto these signals and used to acquire and track the signals from satellites, are within 1 MHz for both L1 and L2 signals. The GPS L5 (1176.45 MHz) “modernized” signal has a PN code chip rate and PN code length that are ten times those of L1 signals. Due to the faster and longer PN code, the acquisition of an L5 signal is more difficult than the acquisition of L1 and L2 signals.

To solve this problem, L1 or L2 signals were first acquired and tracked. The information from the tracked channels was used to narrow down the time/frequency search for acquiring L5 signals.

One issue with the above approach is emergence of requirements for direct acquisition of an L5 signal, without first acquiring L1 or L2 signals.

To overcome these issues, systems and methods are described herein for L5 direct acquisition and L5 Neumann Hoffman (NH) sync functionality.

The above approaches improve on previous methods because they do not require the acquisition and tracking of L1 or L2 signals to narrow the time/frequency search. Accordingly, GNSS systems may operate in an L1-only mode, an L5-only mode, or an L1 and L5 mode, allowing for flexibility to operate in a most efficient configuration for power and performance.

In an embodiment, a method is provided in which data is loaded from a memory to an input sample memory (ISM) of a user equipment (UE). The data corresponds to input from an L5 antenna of the UE. A first high-resolution correlation (HRC) engine of the UE performs coherent correlation and accumulation on the data for at least one code-frequency offset combination, to generate coherent correlation results. A second HRC engine of the UE processes the coherent correlation results by at least performing frequency widening and non-coherent accumulation to generate non-coherent correlation results indicating at least peak accumulations of correlations.

In an embodiment, a UE is provided that includes an ISM configured to store data from a memory. The data corresponds to input from an L5 antenna of the UE. The UE also includes a first HRC engine configured to perform coherent correlation and accumulation on the data for at least one code-frequency offset combination, to generate coherent correlation results. The UE also includes a second HRC engine configured to process the coherent correlation results by at least performing frequency widening and non-coherent accumulation to generate non-coherent correlation results indicating at least peak accumulations of correlations.

In an embodiment, a UE is provided that includes a processor and a non-transitory computer readable storage medium that stores instructions. When executed, the instructions cause the processor to load data from a memory to an ISM of a UE. The data corresponds to input from an L5 antenna of the UE. The instructions also cause the processor to perform, by a first HRC engine of the UE, coherent correlation and accumulation on the data for at least one code-frequency offset combination, to generate coherent correlation results. The instructions further cause the processor to process, by a second HRC engine of the UE, the coherent correlation results by at least performing frequency widening and non-coherent accumulation to generate non-coherent correlation results indicating at least peak accumulations of correlations.

### BRIEF DESCRIPTION OF THE DRAWINGS

In the following section, the aspects of the subject matter disclosed herein will be described with reference to exemplary embodiments illustrated in the figures, in which:

FIG. 1 is a diagram illustrating a communication system, according to an embodiment;

FIG. 2 is a diagram illustrating a GNSS signal processing system, according to an embodiment;

FIG. 3 is a diagram illustrating a system for L5 signal direct acquisition processing, according to an embodiment;

FIG. 4 is a diagram illustrating a system for L5 signal direct acquisition processing in an NH sync mode, according to an embodiment;

FIG. 5 is a diagram illustrating a data flow and a processing order for L5 signal direct acquisition processing, according to an embodiment;

FIG. 6 is a diagram illustrating a data flow and processing order for L5 signal direct acquisition processing in an NH sync mode, according to an embodiment;

FIG. 7 is a flowchart illustrating a method for L5 signal direct acquisition processing at the unified configurable HRC (ucHRC) SS2, according to an embodiment;

FIG. 8 is a flowchart illustrating a method for L5 signal direct acquisition processing at the ucHRC SS3, according to an embodiment;

FIG. 9 is a flowchart illustrating a method for L5 signal direct acquisition processing in an NH sync mode, according to an embodiment;

FIG. 10 is a diagram illustrating code and frequency execution order for L5 signal direct acquisition, according to an embodiment;

FIG. 11 is a diagram illustrating forms of storage for correlation processing at the ISM, according to an embodiment

FIG. 12 is a diagram illustrating code step implementation for L5 signal direct acquisition, according to an embodiment;

FIG. 13 is a diagram illustrating a processing order for NH alignment per pre-detection integration interval (PDI), according to an embodiment;

FIG. 14 is a diagram illustrating an ISM for L5 signal direct acquisition, according to an embodiment;

FIG. 15 is a diagram illustrating an ISM for L5 signal direct acquisition in an NH sync mode, according to an embodiment;

FIG. 16 is a diagram illustrating ucHRC RAM coherent buffer storage, according to an embodiment;

FIG. 17 is a diagram illustrating an NCS structure for L5 signal direct acquisition, according to an embodiment;

FIG. 18 is a diagram illustrating an NCS structure for L5 signal direct acquisition in an NH sync mode, according to an embodiment;

FIG. 19 is a diagram illustrating a peak regions buffer for L5 signal direct acquisition, according to an embodiment;

FIG. 20 is a diagram illustrating an order for updating peaks and peak regions, according to an embodiment;

FIG. 21 is a diagram illustrating ucHRC SS2 data flow in L5 signal direct acquisition, according to an embodiment;

FIG. 22 is a diagram illustrating ucHRC SS3 data flow in L5 signal direct acquisition, according to an embodiment;

FIG. 23 is a diagram illustrating ucHRC SS3 data flow in L5 signal direct acquisition in an NH sync mode, according to an embodiment;

FIG. 24 is a flowchart illustrating a method for L5 signal direct acquisition processing, according to an embodiment; and

FIG. 25 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

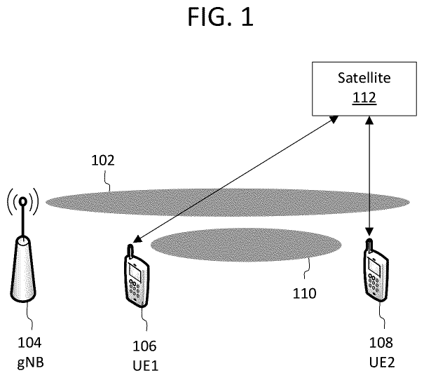

FIG. 1 is a diagram illustrating a communication system, according to an embodiment. In the architecture illustrated in FIG. 1, a control path 102 may enable the transmission of control information through a network established between a base station, access point (AP), or a gNode B (gNB) 104, a first user equipment (UE) 106, and a second UE 108. A data path 110 may enable the transmission of data (and some control information) between the first UE 106 and the second UE 108. The control path 102 and the data path 110 may be on the same frequency or may be on different frequencies. A satellite 112 may provide GNSS signals to the first UE 106 and the second UE 108.

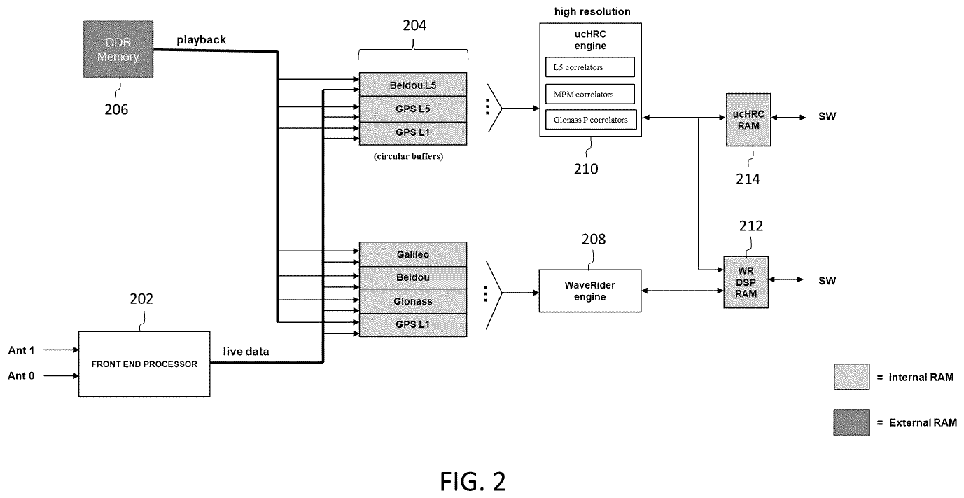

FIG. 2 is a diagram illustrating a GNSS signal processing system, according to an embodiment. The system includes a front end processor (FEP) 202 that may receive radio frequency (RF) inputs from two antennas after the RF inputs have been converted into a digital data stream. The FEP 202 may perform digital frequency mixing, filtering, noise removal, and quantization. Resultant data streams may be output from the FEP 202 and may be saved in a set of circular buffers, or input sample memories (ISMs) 204, with various data widths and various sample frequencies. The ISMs 204 may have regions for different global network satellite systems (GNSSs) for a normal resolution correlator engine 208 to process (e.g., Galileo, Beidou, Glonass, and GPS L1), and regions for different GNSSs for a ucHRC 210 to process (e.g., Beidou L5, GPS L5, and GPS L1). The ISMs 204 may also save playback data from a double data rate (DDR) memory 206, which may be an external random access memory (RAM).

Data from the ISMs 204 may be processed by the two correlator engines 208 and 210 in a time multiplexed fashion. Specifically, the data from the ISMs 204 may be replayed into the correlator engines 208 and 210 at a very high rate so that various satellite constellations (e.g., GPS, Galileo, Beidou, and Glonass) may be simultaneously acquired and tracked by the correlator engines 208 and 210. The normal resolution correlator engine (e.g., Waverider) 208 may be used for acquiring and tracking normal resolution ISM data. Specifically, the normal resolution correlator engine 208 may process live data for acquisition, reacquisition, or tracking, and may process playback data for acquisition, test reacquisition, or test tracking.

The ucHRC 210 may track L5 signals. Specifically, the ucHRC 210 may process ISM data of higher frequency and larger data width (number of bits) than the normal resolution correlator engine 208, but as a result it may only search through a smaller time/frequency window for a new signal. Specifically, the ucHRC 210 may process live data for reacquisition or tracking, may process playback data for test reacquisition or test tracking, and may process on demand playback data for L5 direct acquisition.

Data from the correlator engines 208 and 210 may be provided to highly configurable memories. A digital signal processing (DSP) RAM 212 may be accessed for normal resolution correlator engine processing and report dumps from ucHRC processing. A RAM 214 may be accessed for ucHRC processing.

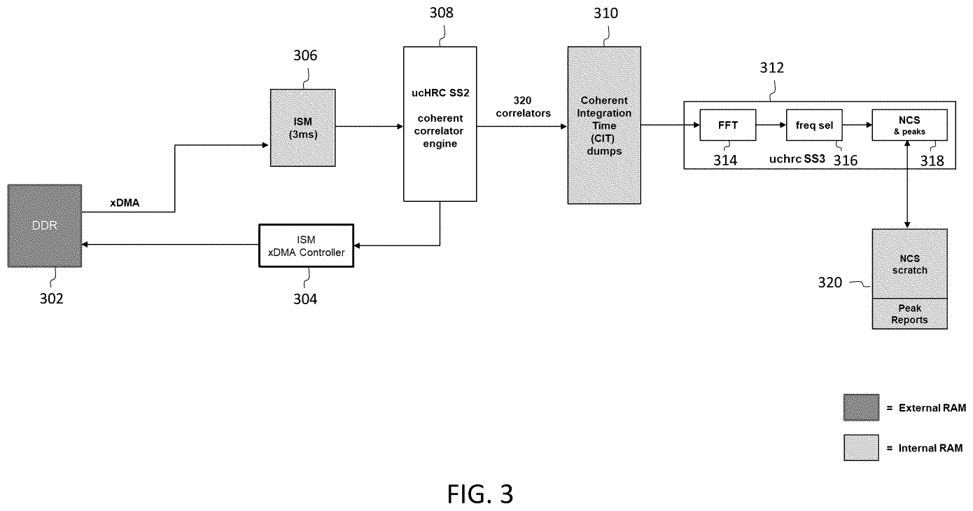

FIG. 3 is a diagram illustrating a system for L5 signal direct acquisition processing, according to an embodiment. L5 ISM data has a high resolution and a high PN code chip rate, and 20460 PN code chips per millisecond (ms) may need to be searched. A frequency range of the search may require six frequency steps.

The system of FIG. 3 may adapt the basic structure of ucHRC processing with an added functionality that allows for direct acquisition of L5 signals with a wide enough search window for the required L5 time/frequency uncertainty, without using information obtained from L1 or L2 signal tracking. A large buffer of data may be captured by processing live data from an L5 antenna through an FEP, and saving the resultant data in a large external DDR memory 302, rather than in the normal circular ISMs 204 of FIG. 2. The ISMs 204 may contain continuous streams of data that with moving windows on the order of several ms long, whereas the external DDR memory 302 may save a single snapshot potentially several hundred ms long. The DDR memory 302 may capture data from live data processing. Once the DDR memory 302 captures data from live data processing, the data may be repeatedly played back into a ucHRC, one time for each L5 satellite that is being acquired. This playback of data may be under the control of an ISM direct memory access (DMA) controller 304 and may be pulled in as needed by correlation engine processing.

Accordingly, data may be pulled in from the DDR memory 302, 1 ms at a time, into a circular 3 ms ISM 306. While FIG. 3 is described with respect to a specific data interval and ISM size, embodiments are not limited to thereto. For example, weak signal acquisition may be performed with a longer PDI if NH alignment is known. The ISM 306 may be in a ucHRC memory or a DSP RAM. A first coherent correlator engine (e.g., ucHRC subsystem 2 (SS2)) 308 may process 1 ms of data for an array of time and a frequency offset, and may accumulate and store the results of each time/frequency offset into a coherent integration time (CIT) memory 310 in a ping-pong fashion. Each ping region and each pong region may have four CIT regions, and each CIT region may include 320 correlator taps. As the ucHRC SS2 308 processes and stores a time/frequency offset into the CIT memory 310 (e.g., ping), a second coherent correlator engine (e.g., ucHRC subsystem 3 (SS3)) 312 may read and process previous coherent data that was stored in the CIT memory 310 (e.g., from the pong region). Accordingly, the ucHRC SS2 308 and the ucHRC SS3 312 may slide across time and frequency ranges that are required for L5 acquisition.

The ucHRC SS2 308 may perform coherent correlation and accumulation, which compares the ISM data against a unique reference code (e.g., PN code) that is modulated onto the signal from each satellite. By correlating the input signal against various time alignments and frequency offsets, accumulating the correlations over time, and looking for peak accumulations, the proper time/frequency alignment may be found. All other time/frequency alignments may look like noise and may have low accumulation values.

The ucHRC SS3 312 may retrieve the coherent data (e.g., data in complex I/Q form) from the CIT memory 310 and perform additional processing at a fast Fourier transform (FFT) module 314, a frequency selection module 316, and a non-coherent summation (NCS) module 318. The FFT module 314 may allow additional frequency bins to be produced, which may be used to widen a frequency range covered by each time/frequency offset. Specifically, the FFT module 314 may perform four-input, eight-point FFT, which outputs eight frequency values for each of the 320 correlator taps. The frequency selection module 316 may discard the outer frequency bins and select the center 5 frequency bins. The NCS module 318 may allow non-coherent (magnitude rather than I/Q) accumulation of the signal over longer periods of time than could be covered by coherent summation. Without this additional processing, the L5 signal structure may limit coherent accumulation to 1 ms. By taking the complex data outputs of the FFT and converting them into magnitudes (non-coherent data), the signals may be NCS accumulated over long periods of time, such as several hundred ms. This may allow the correct time/frequency offset to grow larger than other offsets, which may be interpreted as noise.

Results of the processing at the ucHRC SS3 312 may be stored in a DSP RAM 320. NCS accumulations may be used as a scratch region, and may be discarded after peaks and reports are generated. Reports may include peaks, peak regions, and associated parameters, as described in greater detail below.

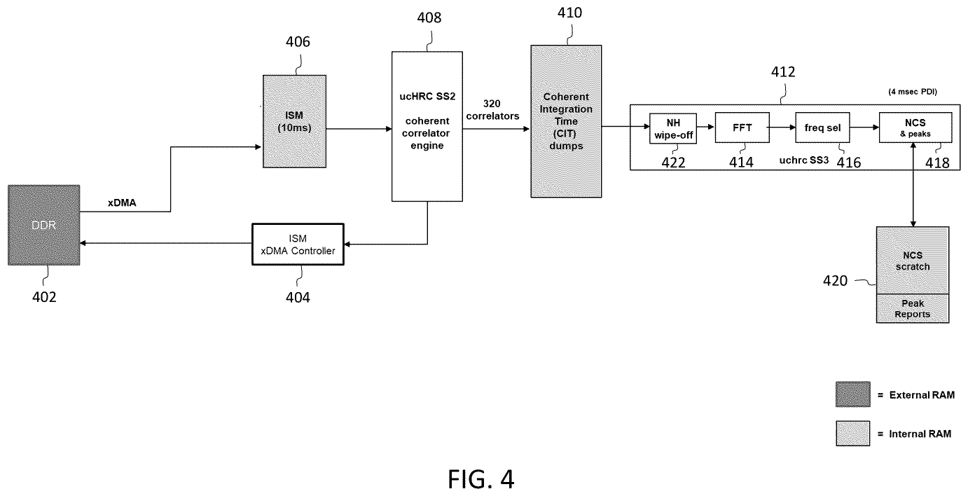

FIG. 4 is a diagram illustrating a system for L5 signal direct acquisition processing in an NH sync mode, according to an embodiment. Specifically, the L5 signal may contain an NH code that is modulated on top of the original signal and the PN code. Each NH code bit is 1 ms long and the NH code bits repeat every 100 ms. While FIG. 4 is described with respect to a specific code bit length and repetition, embodiments are not limited to thereto and may differ for different signals. The L5 signal direct acquisition process may find the correct time/frequency of the signal within 1 ms by limiting coherent integration to 1 ms, but this does not inform which of the possible repeating 100 NH code alignments is correct. This determination may be performed by the L5 signal NH sync mode. Only one code step and one frequency step are required since NH bit sync is performed after L5 signal direct acquisition has found the correct tap and frequency location.

Data may be pulled in from a DDR memory 402, 10 ms at initialization and then 4 ms at a time, into a circular 10 ms ISM 406, as controlled by an ISM DMA controller 404. While FIG. 4 is described with respect to a specific data interval and ISM size, embodiments are not limited to thereto. The ISM 406 may be in a ucHRC memory or a DSP RAM. A ucHRC SS2 408 may process 4 ms of data for an array of time and a frequency offset, and may accumulate and store the results of each time/frequency offset into a CIT memory 410.

The ucHRC SS2 408 may perform coherent correlation and accumulation which compares the ISM data against a unique reference code (e.g., PN code) that is modulated onto the signal from each satellite, as described above with respect to FIG. 3.

A ucHRC SS3 412 may retrieve the coherent data (e.g., data in complex I/Q form) from the CIT memory 410. The ucHRC SS3 412 repeatedly processes the CIT data, but for each pass it uses a different NH code alignment, at NH wipe-off module 422. Only the correct alignment will produce a large NCS signal. The ucHRC SS3 412 may perform additional processing at an FFT module 414, a frequency selection module 416, and an NCS module 418, as described above with respect to FIG. 3.

Results of the processing at the ucHRC SS3 412 may be stored in a DSP RAM 420. NCS accumulations may be used as a scratch region, and may be discarded after peaks and reports are generated.

With respect to handshake controls, the ucHRC SS2 may set (and the ucHRC SS3 may reset) a “pdiAReady” parameter and a “pdiBReady” parameter, which inform the ucHRC SS3 when ping or pong data is ready to be processed. The ucHRC SS3 may also set (and the ucHRC SS2 may reset) a “terminate” parameter to inform the ucHRC SS2 that it has completed the processing of all code and frequency steps for all noncoherent dwells (ncsCountMod) (e.g., 150 ms of data processed in 150 PDIs), and that the ucHRC SS2 may move on to a next channel. The ucHRC SS2 may control scale values associated with the four CIT coherent accumulations for a PDI, information about a current channel being processed, and locations of where to store and use data. The ucHRC SS2 may also control information about a current count of data being processed, such as, for example, code step, frequency step, NCS count, and NH step. The NCS count may be the current PDI number being processed, and the NH step may be the NH alignment offset number (used for NH bit sync).

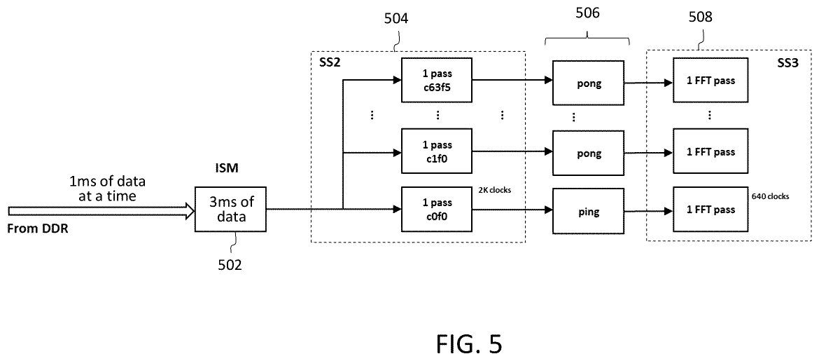

FIG. 5 is a diagram illustrating a data flow and a processing order for L5 signal direct acquisition processing, according to an embodiment. A new 1 ms of data may be loaded into a 3 ms circular ISM 502 from a DDR memory. A ucHRC SS2 504 may process this data once for each code step and each frequency step (e.g., (c0, f0), (c1, f0), . . . (c63, f0), (c0, f1), . . . (c63, f5). After each step is processed by the ucHRC SS2 504, it stores the coherent correlation results at a CIT memory 506 in a ping-pong fashion for a ucHRC SS3 508 to process, which follows behind processing of the ucHRC SS2 504, as described above with respect to FIG. 3. After all code steps and frequency steps are processed, the next 1 ms of data may loaded into the ISM 502 from the DDR memory, or a next 1 ms of data may be preloaded into the ISM 502 while the current 1 ms is being used. This process may be repeated until all data from the DDR memory is processed (e.g., 150 PDIs of 1 ms each).

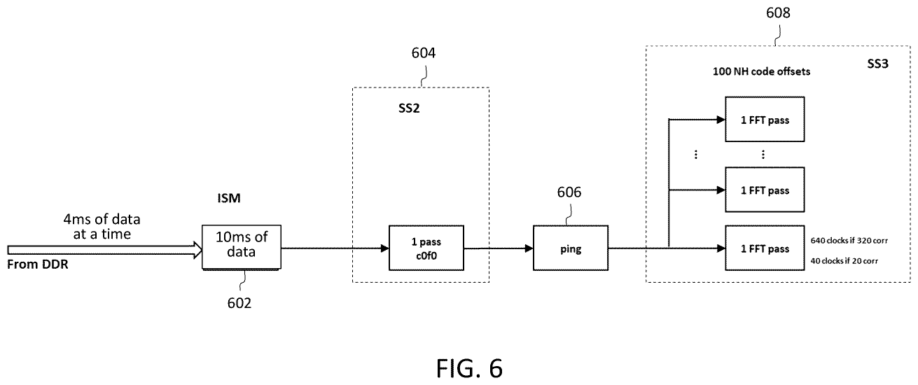

FIG. 6 is a diagram illustrating a data flow and processing order for L5 signal direct acquisition processing in an NH sync mode, according to an embodiment. A new set of 4 ms of data may be loaded into a 10 ms circular ISM 602 from a DDR memory. A ucHRC SS2 604 may process this data once and write the coherent correlation results one time directly and unmodulated into a CIT memory 606. Modulation of four 1 ms CIT data with different NH alignments may be performed in a ucHRC SS3 608. For each NH alignment, the ucHRC SS3 608 may modulate each of the four 1 ms CIT data with an NH bit (e.g., [NH(0), NH(1), NH(2), NH(3)], [NH(4), NH(5), NH(6), NH(7)], . . . ). After all NH alignments are processed, the next 4 ms of data may be loaded into the ISM 602 from the DDR memory, or a next 4 ms of data may be preloaded into the ISM 602 while the current 4 ms is being used. This process may be repeated until all the data from the DDR memory is processed (e.g., 150/4=37 PDI of 4 ms each).

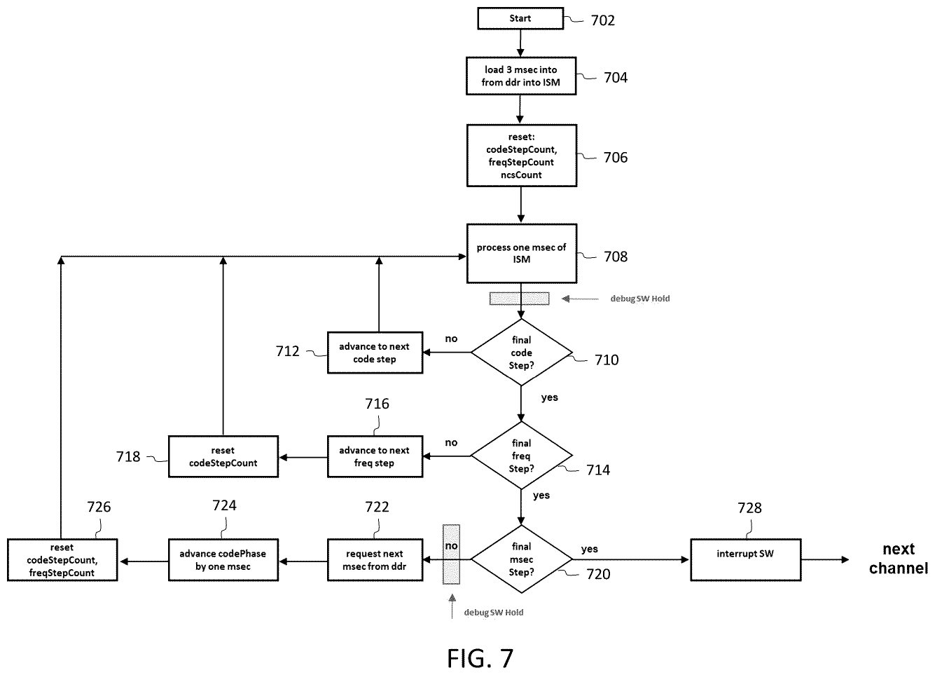

FIG. 7 is a flowchart illustrating a method for L5 signal direct acquisition processing at the ucHRC SS2, according to an embodiment. The methodology begins at 702, and 3 ms of data may be loaded from a DDR memory into an ISM, at 704, as described above with respect to FIGS. 3 and 5. At 706, the ucHRC SS2 may reset a code step count, a frequency step count, and an NCS count. At 708, the ucHRC SS2 may process 1 ms of ISM data in a series of code and frequency steps, as described above with respect to FIG. 5. At 710, the ucHRC SS2 may determine whether a processed code/frequency step of ISM data was at a final code step based on the code step count. If the ucHRC SS2 determines that the processed code/frequency step of ISM data was not at a final code step, the ucHRC SS2 may increase the code step count at 712, and may return to 708 to process a next code/frequency step of ISM data.

If the ucHRC SS2 determines that the processed code/frequency step of ISM data was at a final code step, the ucHRC SS2 may determine whether the processed code/frequency step of ISM data was at a final frequency step, at 714. If the ucHRC SS2 determines that the processed code/frequency step of ISM data was not at a final frequency step, the ucHRC SS2 may increase the frequency step count at 716 and may reset the code step count at 718, before the returning to 708 to process a next code/frequency step of ISM data.

If the ucHRC SS2 determines that the processed code/frequency step of ISM data was at a final frequency step, the ucHRC SS2 may determine whether the processed 1 ms of data is the final ms of data from the DDR memory, at 720. If the ucHRC SS2 determines that the processed 1 ms of data was not the final ms of data from the DDR memory, the ucHRC SS2 may request a next 1 ms of data from the DDR memory at 722, increase the NCS count at 724, and reset the code step count and the frequency step count at 726, before returning to 708 to process a code/frequency step of the next ms of data from the ISM. If the processed 1 ms of data was the final ms of data from the DDR memory, the ucHRC SS3 may retain NCS peaks at 728, before processing a next channel.

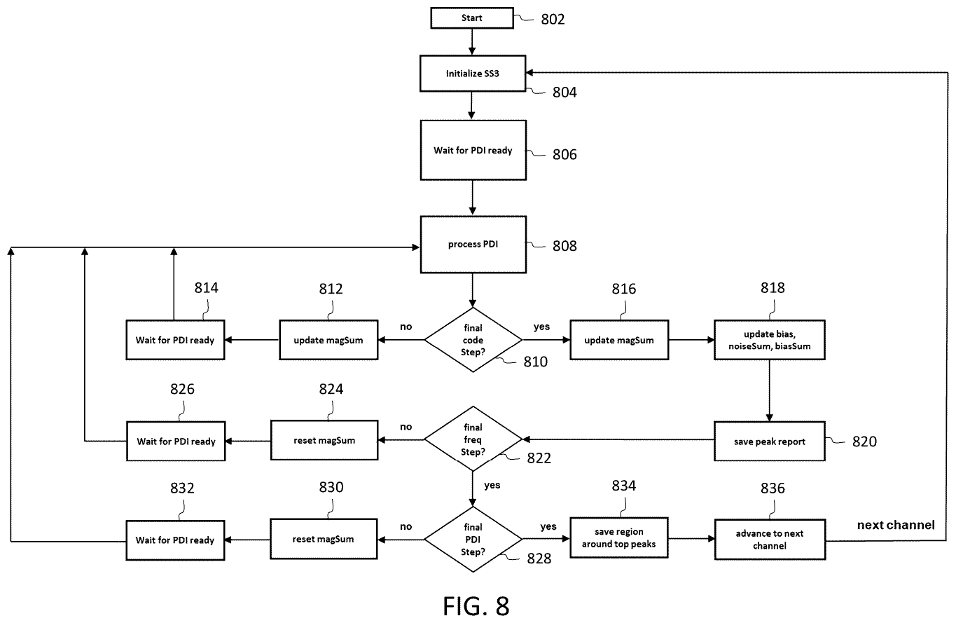

FIG. 8 is a flowchart illustrating a method for L5 signal direct acquisition processing at the ucHRC SS3, according to an embodiment. The methodology begins at 802, and the ucHRC SS3 may be initialized at 804. The ucHRC SS3 may await for a PDI ready notification at 806, and may process a ready PDI at 808.

At 810, the ucHRC SS3 may determine whether the processed PDI is at a final code step. If the ucHRC SS3 determines that the PDI is not at the final code step, the ucHRC SS3 may update magSum at 812 and may await for a next ready PDI at 814, before returning to 808 to process the next PDI. If the ucHRC SS3 determines that the PDI is at the final code step, the ucHRC SS3 may update magSum at 816, and may update a bias, a biasSum, and a noiseSum at 818. The ucHRC SS3 may save a peak report at 820.

At 822, the ucHRC SS3 may determine whether the processed PDI is at a final frequency step. If the ucHRC SS3 determines that the PDI is not at the final frequency step, the ucHRC SS3 may reset magSum at 824 and may await for a next ready PDI at 826, before returning to 808 to process the next PDI. If the ucHRC SS3 determines that the PDI is at the final frequency step, the ucHRC SS3 may determine whether the processed PDI is at a final PDI step at 828. If the ucHRC SS3 determines that the processed PDI is not at the final PDI step, the ucHRC SS3 may reset magSum at 830 and may await for a next ready PDI at 832, before returning to 808 to process the next PDI.

If the ucHRC SS3 determines that the processed PDI is the final PDI, the ucHRC SS3 may save a region around top peaks and may advance to a next channel at 834, before returning to 804 to initialize the ucHRC SS3.

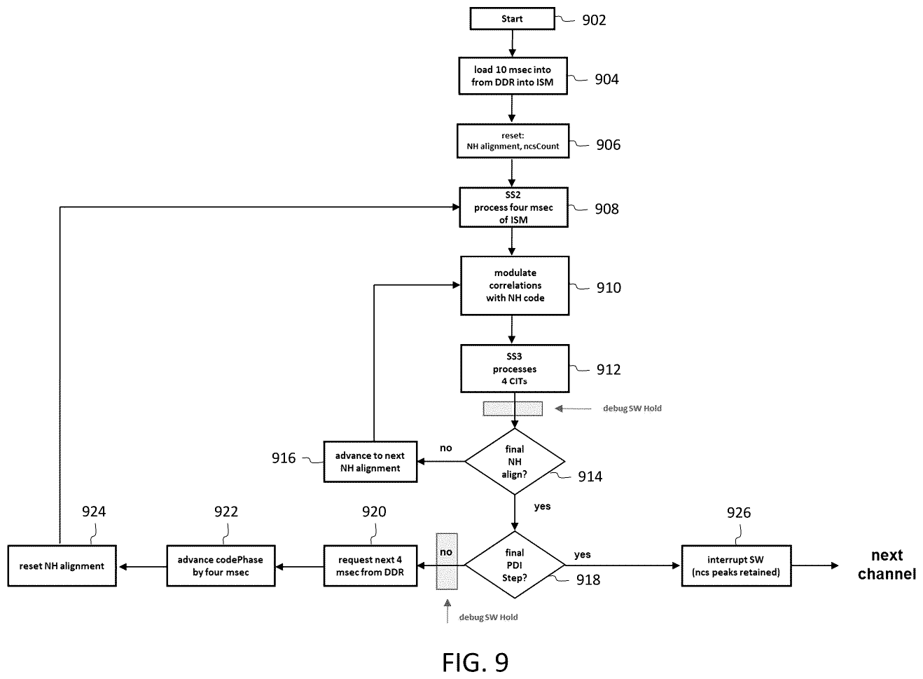

FIG. 9 is a flowchart illustrating a method for L5 signal direct acquisition processing in an NH sync mode, according to an embodiment. The methodology begins at 902, and 10 ms of data may be loaded from a DDR memory into am ISM, at 904. At 906, the ucHRC SS2 may reset an NH alignment and an NCS count. At 908, the ucHRC SS2 may processes 4 ms of data from the ISM. At 910, the ucHRC SS3 may modulate correlations with an NH code, and at 912, the ucHRC SS3 may process four CITs. At 914, the ucHRC SS3 may determine whether the processed CITs are at a final NH alignment. If the ucHRC SS3 determines that the processed CITs are not at the final NH alignment, the ucHRC SS3 may advance to a next NH alignment at 916, before returning to modulate correlations with an NH code at 910. If the ucHRC SS3 determines that the processed CITs are at the final NH alignment, the ucHRC SS3 may determine whether PDI is at the final PDI step. If the ucHRC SS3 determines that the PDI is not at the final PDI step, the ucHRC SS2 may requests the next 4 ms of data from the DDR memory at 920, advance the NCS count by 4 ms at 922, and reset the NH alignment at 924, before returning to 908 for the ucHRC SS2 to process the next 4 ms of data from the ISM at 908. If the ucHRC SS3 determines that the PDI is at the final PDI step, the NCS peaks may be retained at 926, before processing a next channel.

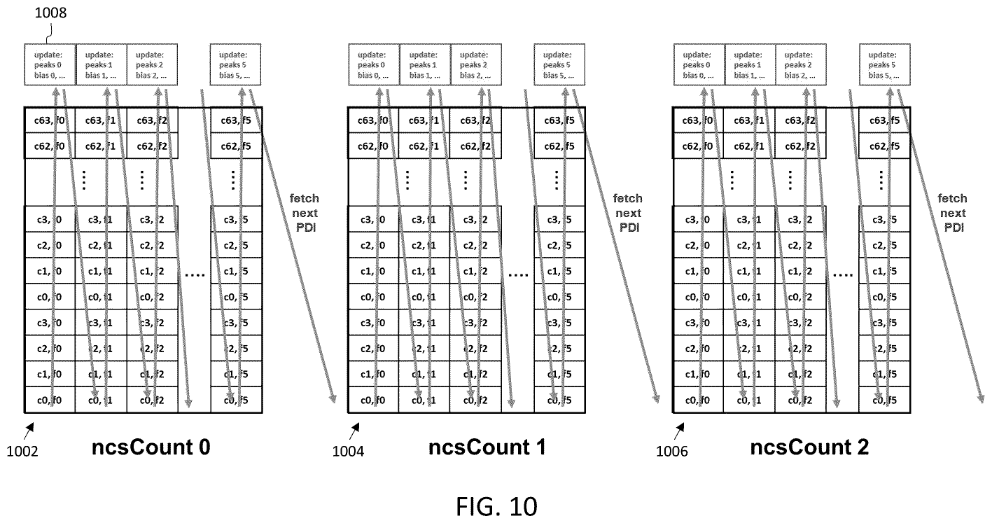

FIG. 10 is a diagram illustrating code and frequency execution order for L5 signal direct acquisition, according to an embodiment. In a first PDI 1002 (ncsCount 0), processing may begin at a first code step and a first frequency step (c0,f0). Processing may proceed through each of the 64 code steps while maintaining the first frequency step (c63,f0), before moving to the first code step at a subsequent frequency step (c0,f1). Processing may proceed through all six frequency steps in a similar manner until reaching the final code step for the final frequency step (c63,f5). After all codes steps and frequency steps are processed for the first PDI 1002, a second PDI (ncsCount 1) 1004 may be retrieved. After all code steps and frequency steps are processed for the second PDI 1004, a third PDI (ncsCount 3) 1006 may be retrieved.

For each frequency step, after all code steps are processed, the eight largest peak correlations of the code steps may be saved in a peaks buffer 1008. The peaks buffer may contain additional information including location (code step/frequency step), bias, and scaling associated with each peak. Each frequency step may generate a separate peaks buffer.

An NCS region includes 320 tap positions for 64 code steps and 6 frequency steps. All tap/code/frequency non-coherent correlations may be accumulated on top of each other every PDI. These correlations are in non-coherent form (i.e., magnitude, not I/Q) and represented as mantissa and exponent (e.g., 8-bit magnitude, 3-bit scale). After all of PDIs have been processed (e.g., 150 PDIs of 1 ms each), and all correlation magnitudes have been accumulated on top of each other, a final set of peak buffers may be generated for each frequency step, as shown and described with respect to FIG. 10. After all PDIs have been processed, a set of peak region buffers may be generated. Each peak region buffer is associated with a peaks buffer and contains the correlations the code/frequency steps surrounding each peak that is in the peaks buffer. This allows for the interpolation of the peak values with the surrounding values.

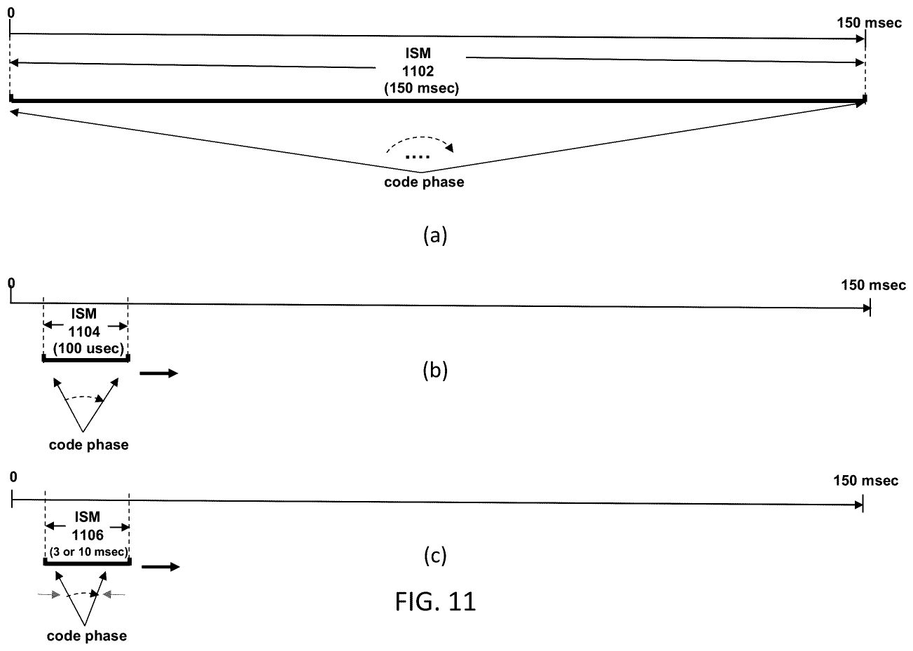

FIG. 11 is a diagram illustrating forms of storage for correlation processing at the ISM, according to an embodiment. A first form of storage, as shown in (a), is one shot storage in which an entire range of data (e.g., 150 ms) is captured and immediately available for correlation engine processing at an ISM 1102. Multiple channels may consecutively process this common ISM 1102. A second form of storage, as shown in (b), is real-time or playback running in real time, in which an ISM 1104 may be a moving window (e.g., 100 microseconds (μs)) advancing in real time or accelerated real time. Multiple channels (running at a high clock speed) may consecutively access this moving window. This allows the ISM data to be used for acquiring and/or tracking multiple satellites simultaneously. A third form of storage, as shown in (c), is on demand storage in which an ISM 1106 is preloaded with the beginning data stored in the DDR memory. Thereafter, all code/frequency steps or NH alignments are processed for the PDI contained in the ISM 1106. When this is completed, the next PDI may be loaded into the ISM in a circular buffer manner and processing is repeated. In this manner, the ISM moving window slides down all available data. Specifically, for L5 direct acquisition, the ISM 1106 is 3 ms receiving 1 ms of data at time. All twenty thousand code taps and six frequency steps are processed before moving on to a next ms. For NH bit synchronization, the ISM 1106 is 10 ms receiving 4 ms of data at a time. All 100 NH code alignments are processed before moving on to a next PDI.

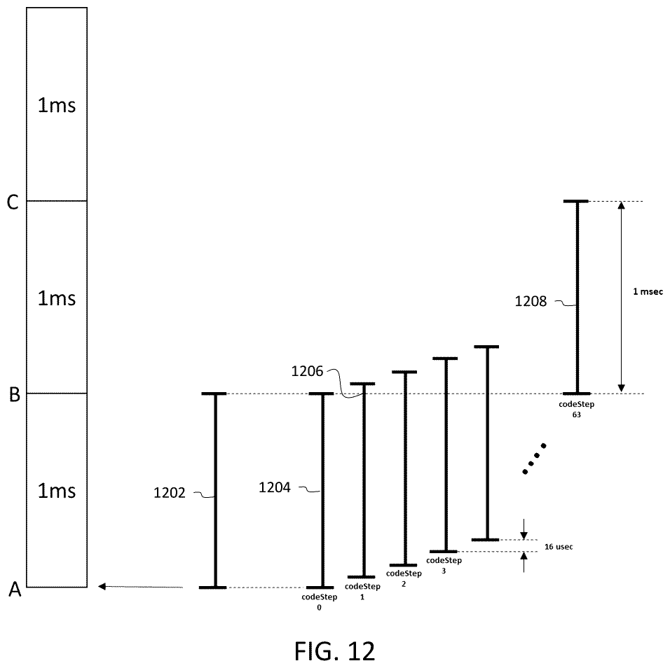

FIG. 12 is a diagram illustrating code step implementation for L5 signal direct acquisition, according to an embodiment. Specifically, FIG. 12 illustrates that codes steps are generated by offsetting a 1 ms data range 1202 processed by a correlation engine. Each code step produces 320 correlator taps that are offset from each other by 1/20 μs, covering a time range of 16 μs. Each code step (e.g., code step-1 1206) is offset from a previous code step (e.g., code step-0 1204) by 16 μs. A final code step-63 1208 may reach a subsequent ms.

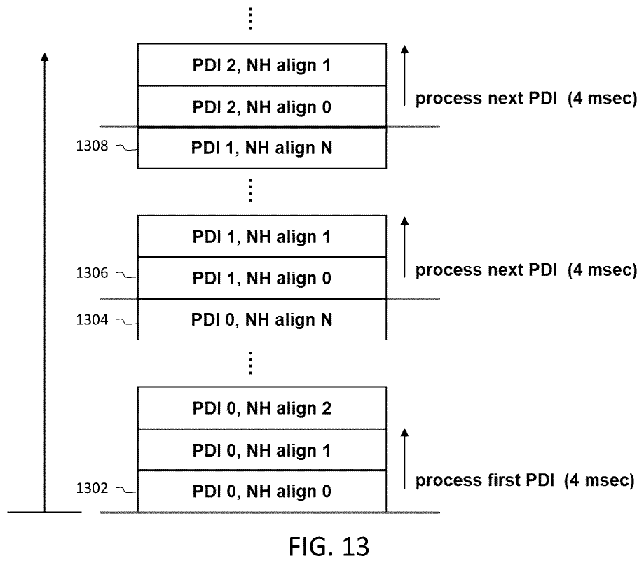

FIG. 13 is a diagram illustrating a processing order for NH alignment per PDI, according to an embodiment. A first 4 ms PDI may be processed beginning at a first NH alignment (PDI 0, NH align 0 1302), through a last NH alignment (PDI 0, NH align N 1304). Subsequently, a second 4 ms PDI may be processed beginning at the first NH alignment (PDI 1, NH align 0 1306), through the last NH alignment (PDI 1, NH align N 1308). This processing continues through all 4 ms PDIs.

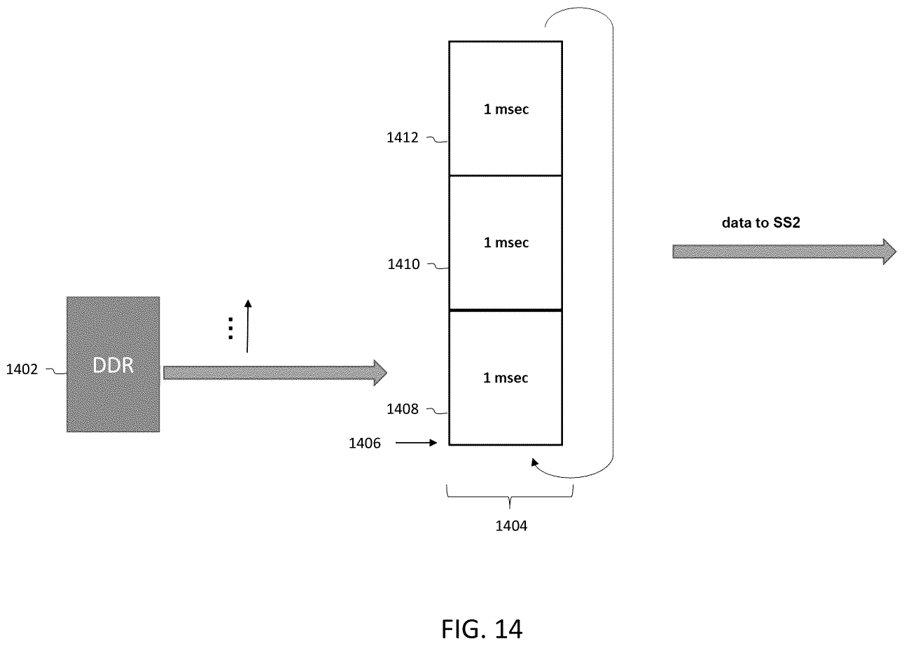

FIG. 14 is a diagram illustrating an ISM for L5 signal direct acquisition, according to an embodiment. Upon request from a ucHRC SS2, data may be pulled from a DDR memory 1402 into a circular 3 ms ISM 1404. A first 1 ms of data 1408 may be stored beginning at an ISM base address 1406, followed by a second and third 1 ms of data 1410 and 1412. A fourth 1 ms of data may then be stored beginning again at the ISM base address 1406. The ucHRC SS2 may process 1 ms of data at a time.

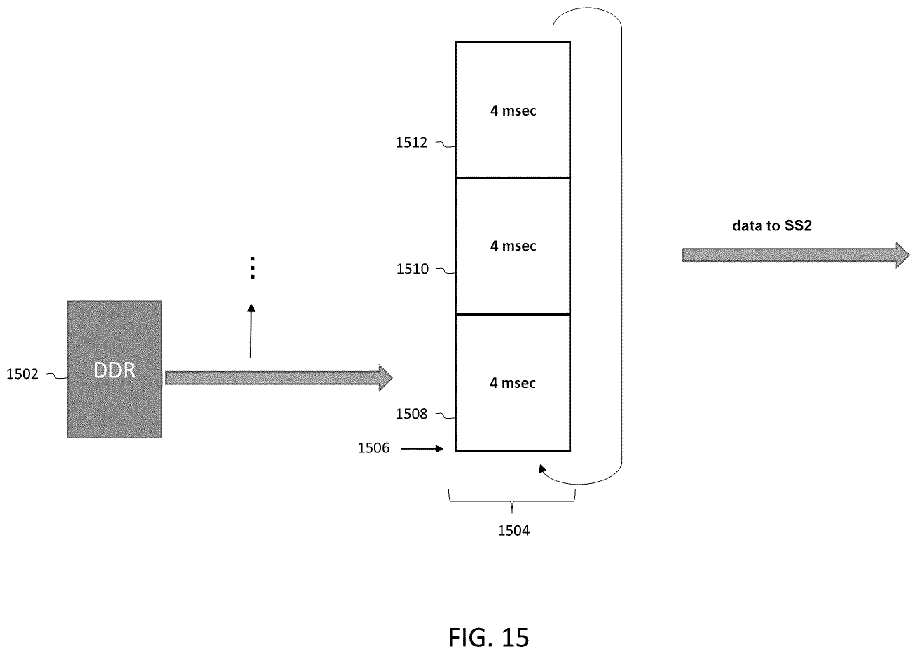

FIG. 15 is a diagram illustrating an ISM for L5 signal direct acquisition in an NH sync mode, according to an embodiment. Upon request from a ucHRC SS2, data may be pulled from a DDR memory 1502 into a circular ISM 1404. A first 4 ms of data 1508 is stored beginning at an ISM base address 1506, followed by a second and third 4 ms of data 1510 and 1512. A fourth 4 ms of data would then be stored beginning again at the ISM base address 1506. The ucHRC SS2 may process 4 ms of data at a time.

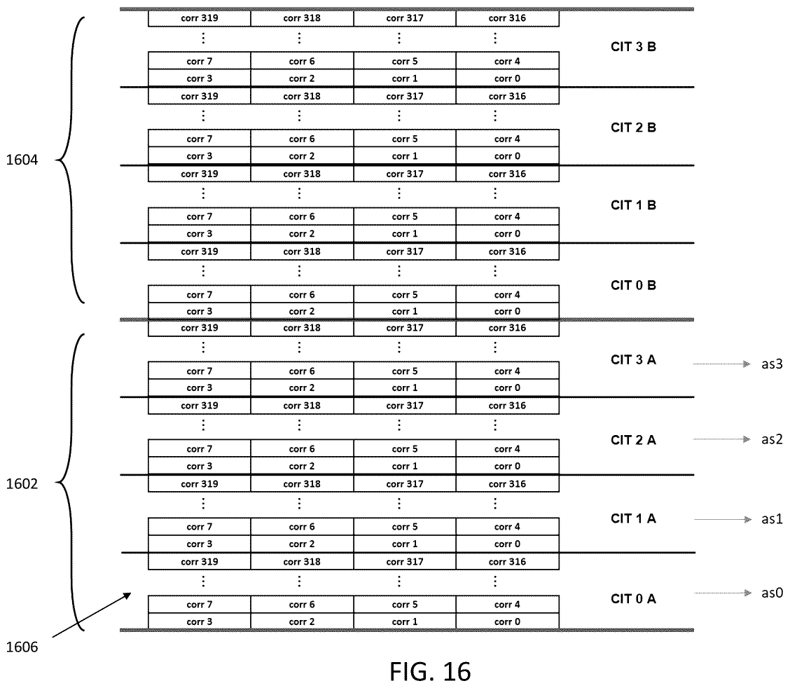

FIG. 16 is a diagram illustrating ucHRC RAM coherent buffer storage, according to an embodiment. The ucHRC SS2 may load data into a ping storage region 1602 while the ucHRC SS3 processes data from a pong storage region 1604, and then vice versa. Each of the ping storage region 1602 and the pong storage region 1604 may contain four CITs 1606. For example, the ping storage region 1602 may include CIT 0 A, CIT 1 A, CIT 2 A, and CIT 3 A, and the pong storage region may include CIT 0 B, CIT 1 B, CIT 2 B, and CIT 3 B. Each CIT is ¼ ms for L5 direct acquisition, and 1 ms for L5 direct acquisition in NH sync mode. While FIG. 16 is described with respect to a specific CIT. embodiments are not limited to thereto. For example, for weak signal acquisition, when NH alignment is known, each CIT may be 1 ms and PDI may be 4 ms. Four CITs make up a single PDI. A PDI is 1 ms for L5 direct acquisition, and 4 ms for L5 direct acquisition in NH sync mode. Each CIT contains 320 correlator taps (e.g., corr 0 through corr 319) spaced 1/20 μs apart. Each CIT may have its own scaling parameter (e.g., AS0, AS1, AS2, and AS3).

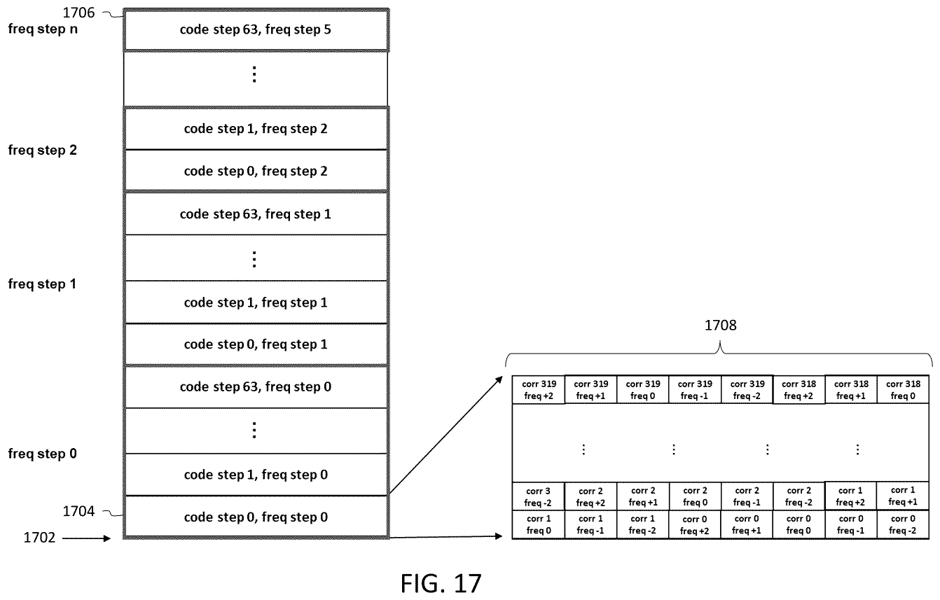

FIG. 17 is a diagram illustrating an NCS structure for L5 signal direct acquisition, according to an embodiment. The NCS structure contains correlation summations for each code step and frequency step, beginning at an NCS base address 1702 with code step 0, frequency step 0 1704, and continuing through code step 63, frequency step 5 1706. Each code/frequency step may contain 320 correlator taps 1708 at 8-bit magnitude, spaced 1/20 μs apart, with each correlator tap having five FFT frequency bins.

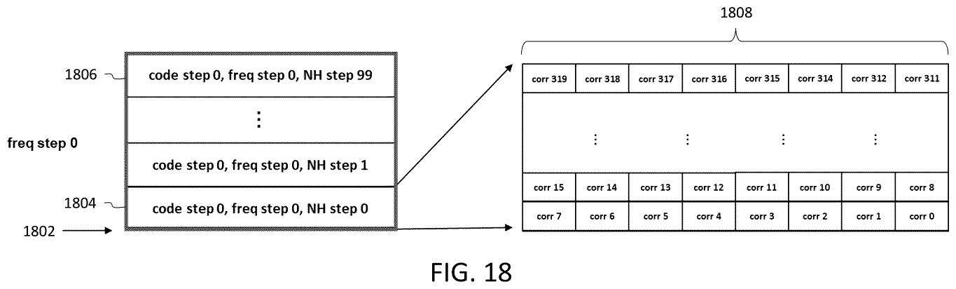

FIG. 18 is a diagram illustrating an NCS structure for L5 signal direct acquisition in an NH sync mode, according to an embodiment. The NCS structure contains correlation summations for each NH code alignment beginning at an NCS base address 1802 with code step 0, frequency step 0, and NH step 0 1804, and continuing through NH step 99 1806. Only code step 0 and frequency step 0 are required since NH bit sync is performed only after L5 signal direct acquisition has found the correct tap and frequency location. Each NH code alignment step contains 320 correlator taps 1808 of 8-bit magnitude, spaced 1/20 μs apart. NH step 0 is [NH(0), NH(1), NH(2), NH(3)]. NH step 1 is [NH(1), NH(2), NH(3), NH(4)]. NH step 2 is [NH(2), NH(3), NH(4), NH(5)].

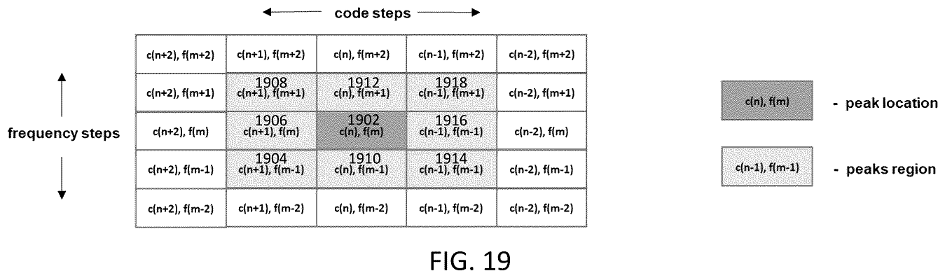

FIG. 19 is a diagram illustrating a peak regions buffer for L5 signal direct acquisition, according to an embodiment. Each peak has an associated peaks region buffer containing all the code/frequency steps surrounding the peak. This allows for interpolation of the correlations around the peak. For example, a peak 1902 at step c(n),f(m), is surrounded by a peaks region at steps c(n+1),f(m−1) 1904, c(n+1),f(m) 1906, c(n+1),f(m+1) 1908, c(n),f(m−1) 1910, c(n),f(m+1) 1912, c(n−1),f(m−1) 1914, c(n−1),f(m) 1916, and c(n−1),f(m+1) 1918.

An NCS memory may be used as a scratch region, meaning that after all code/frequency steps have been performed, after all PDIs have been processed, and after all peaks and peak regions have been generated, the sequencer may move on to L5 signal direct acquisition for a next satellite or channel. While the NCS region may be cleared for reuse for the next satellite or channel, ping-pong memory regions for peaks and peak regions may be utilized to allow the last satellite's data to be available for software while the next satellite is being processed. The peaks memory may contain six peak buffers (one for each frequency step), each peak buffer may contain eight peaks, and each peak may have an associated peak region buffer, as described above.

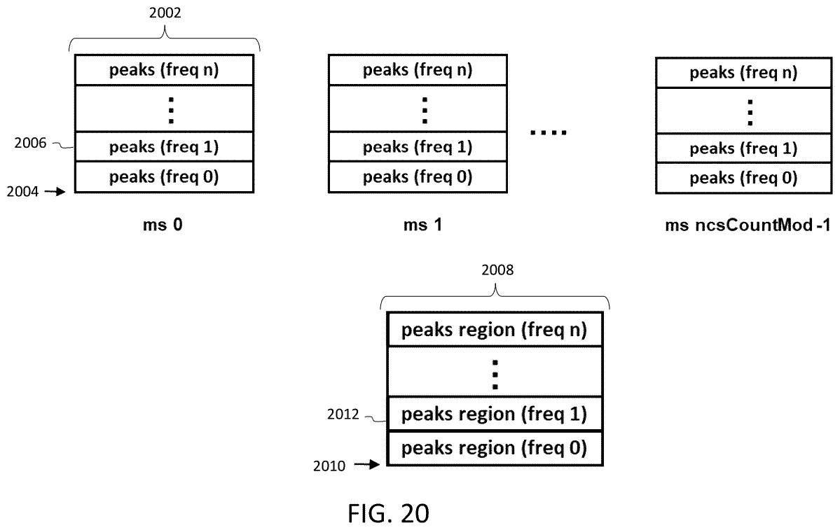

FIG. 20 is a diagram illustrating an order for updating peaks and peak regions, according to an embodiment. After processing every PDI (1 ms each) for all code and frequency steps, a set of peak buffers 2002 are generated beginning at a peaks base address 2004. One peak buffer 2006 is generated for each frequency step. Each peak buffer 2006 may contain eight peaks, but embodiments are not limited thereto. One peak region, having nine points or steps as shown in FIG. 19, is generated for each peak. A peaks region may be generated after each frequency step is completed for a PDI. After all PDIs have been processed (e.g., 150 PDIs for 150 ms of data), a set of peak region buffers 2008 are generated beginning a peak region base address 2010. A peak region buffer 2012 is generated for each frequency step. The NCS region may be used as scratch, meaning the peak and peak region buffers are saved for software, but the NCS region can be used for processing a next satellite.

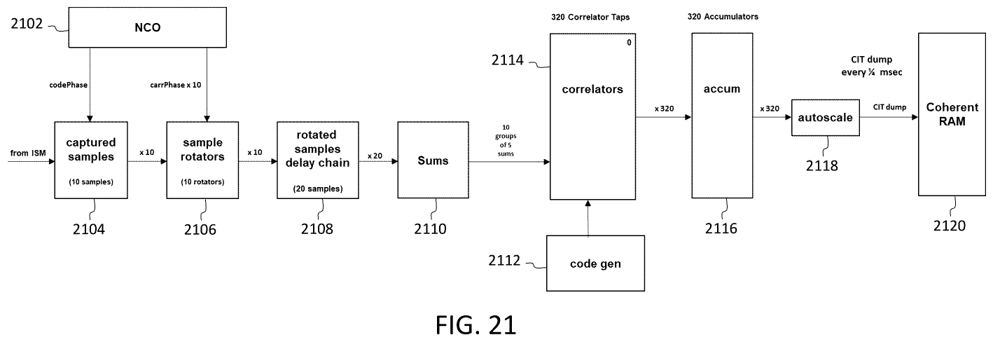

FIG. 21 is a diagram illustrating ucHRC SS2 data flow in L5 signal direct acquisition, according to an embodiment. A numerically controlled oscillator (NCO) 2102 may provide a code phase to enable selection of samples 2104 from an ISM (e.g., 10 samples). The NCO 2102 may also provide a carrier phase (e.g., ×10) for use at sample rotators 2106 (e.g., ×10) to rotate the captured samples 2104. The rotated samples may be formed into a delay chain 2108 (e.g., 20 samples) and may be summed up to 1/10 μs samples. Summed samples 2110 (e.g., 10 groups of 5 sums) may be correlated against various offsets for a PN code from code generator 2112 at correlators 2114. Each offset of code against samples represents another correlator tap. Correlations for all of the correlator taps (e.g., 320) may be accumulated at accumulator 2116, autoscaled at an autoscale module 2118 up to a CIT (¼ ms), and then dumped into a coherent RAM 2120. Four CITs may be saved up to form a PDI for the ucHRC SS3 to process.

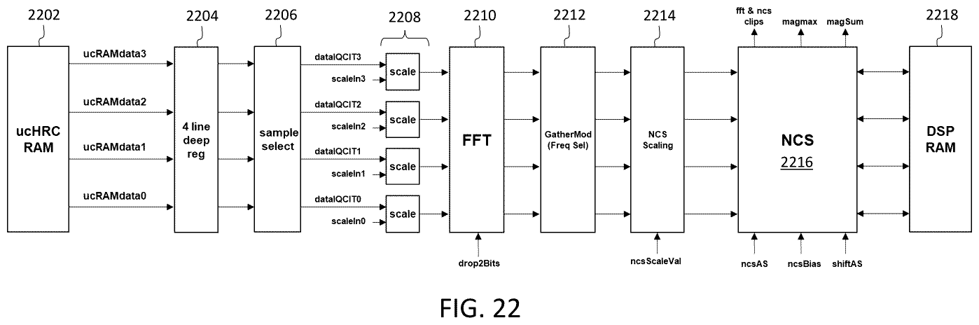

FIG. 22 is a diagram illustrating ucHRC SS3 data flow in L5 signal direct acquisition, according to an embodiment. Four lines of data (e.g., ucRAMdata0, ucRAMdata1, ucRAMdata2, and ucRAMdata3) may be read from ucHRC RAM 2202 to a four-line deep register 2204. A sample selection module 2206 may select four CIT samples (e.g., dataIQCIT0, dataIQCIT1, dataIQCIT2, and dataIQCIT3) for a single correlator tap, which undoes “twiddling” to allow efficient FFT butterfly sample input requirements. The four CIT samples may be individually scaled at scale modules 2208, before being input to a four-input, eight-point FFT module 2210 for FFT processing. A gather module (or frequency selection module) 2112 may allow only the center five frequency bins through to an NCS scaling module 2214, since outer bins have signal strength drop-off. The NCS scaling module may scale inputs before an NCS module 2216 performs non-coherent (magnitude) accumulation. Assorted bias and scaling parameters are generated to allow efficient use of data ranges.

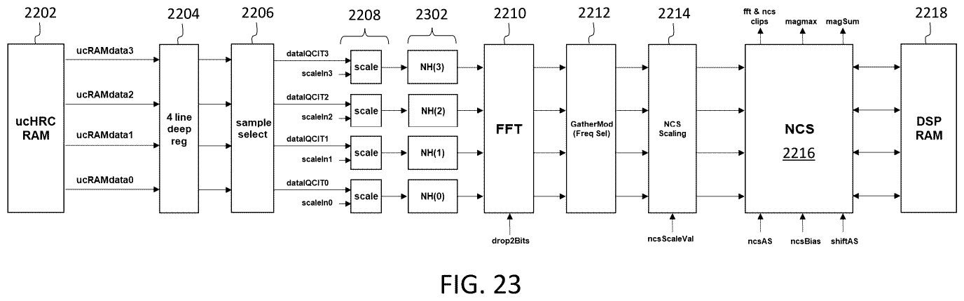

FIG. 23 is a diagram illustrating ucHRC SS3 data flow in L5 signal direct acquisition in an NH sync mode, according to an embodiment. The data flow of FIG. 23 functions similarly to the flow described above with respect FIG. 22, and contains similar modules, with the exception of the addition of individual NH wipeoff modules 2302 (e.g., NH(0), NH(1), NH(2), and NH(3)), which receive input from the individual scale modules 2208 and provide output to the FFT module 2210.

While it is described that PDI=1 ms for L5 signal acquisition and PDI=4 ms for L5 signal acquisition with NH sync, embodiments are not limited thereto and various PDI settings may be used to help optimize system performance.

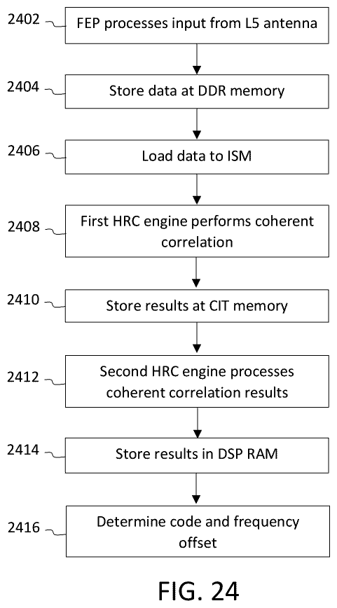

FIG. 24 is a flowchart illustrating a method for L5 signal direct acquisition processing, according to an embodiment.

At 2402, an FEP of a UE may process input from an L5 antenna after conversion into a digital data stream. At 2404, the processed data may be stored at a DDR memory. At 2406, the data may be loaded from the DDR memory to an ISM of the UE.

At 2408, a first HRC engine of the UE may perform coherent correlation and accumulation on the data for at least one code-frequency offset combination, to generate coherent correlation results. The data may include 1 ms of data or 4 ms of data. The at least one code-frequency offset combination may include a plurality of offset combinations, the coherent correlation and accumulation may be sequentially performed on the data for each offset combination to generate coherent correlation results for each offset combination. The coherent correlation results may include code-frequency offsets with peak accumulations of correlations over time.

At 2410, each coherent correlation result may be stored at a CIT memory of the UE. Each region of the CIT may include four CIT regions, and each CIT region may include 320 correlator taps.

At 2412, a second HRC engine of the UE may process the coherent correlation results by at least performing frequency widening and non-coherent accumulation to generate non-coherent correlation results indicating at least peak accumulations of correlations. One of a first region and a second region of the CIT memory is used for data storage by the first HRC engine while another of the first region and the second region is accessed for data retrieval by the second HRC engine in a ping-pong manner. The processing of the coherent correlation results may include performing FFT on the coherent correlation results to widen a frequency range covered by a respective code-frequency offset, selecting a number of center frequencies from the widened frequency range for the respective code-frequency offset, and performing non-coherent accumulation on the FFT coherent correlation results, with respect to the number of center frequencies, to increase an accumulation time and generate the non-coherent correlation results. The coherent correlation results may be processed for each of a plurality of NH code alignments. The non-coherent correlation results may include code-frequency offsets with peak accumulations of correlations, and code-frequency offset regions of the peak accumulations.

At 2414, the non-coherent correlation results may be stored in a DSP RAM of the UE. At 2416, a code offset and frequency offset may be determined for the input based on the non-coherent correlation results.

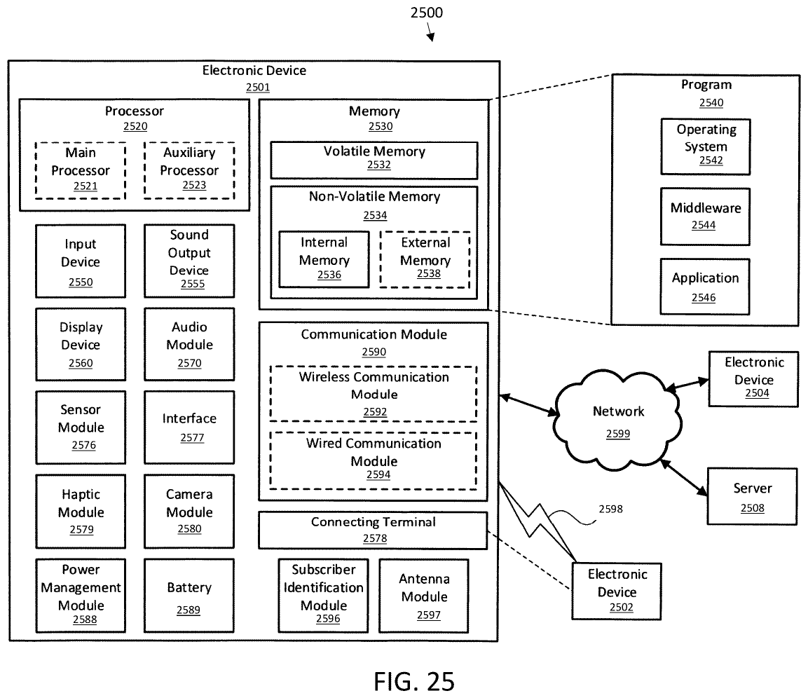

FIG. 25 is a block diagram of an electronic device in a network environment 2300, according to an embodiment.

Referring to FIG. 25, an electronic device 2501 in a network environment 2500 may communicate with an electronic device 2502 via a first network 2598 (e.g., a short-range wireless communication network), or an electronic device 2504 or a server 2508 via a second network 2599 (e.g., a long-range wireless communication network). The electronic device 2501 may communicate with the electronic device 2504 via the server 2508. The electronic device may be embodied as the UE described above with respect to FIGS. 1-3. The electronic device 2501 may include a processor 2520, a memory 2530, an input device 2550, a sound output device 2555, a display device 2560, an audio module 2570, a sensor module 2576, an interface 2577, a haptic module 2579, a camera module 2580, a power management module 2588, a battery 2589, a communication module 2590, a subscriber identification module (SIM) card 2596, or an antenna module 2597. In one embodiment, at least one (e.g., the display device 2560 or the camera module 2580) of the components may be omitted from the electronic device 2501, or one or more other components may be added to the electronic device 2501. Some of the components may be implemented as a single integrated circuit (IC). For example, the sensor module 2576 (e.g., a fingerprint sensor, an iris sensor, or an illuminance sensor) may be embedded in the display device 2560 (e.g., a display).

The processor 2520 may execute software (e.g., a program 2540) to control at least one other component (e.g., a hardware or a software component) of the electronic device 2501 coupled with the processor 2520 and may perform various data processing or computations, including GNSS processing.

As at least part of the data processing or computations, the processor 2520 may load a command or data received from another component (e.g., the sensor module 2576 or the communication module 2590) in volatile memory 2532, process the command or the data stored in the volatile memory 2532, and store resulting data in non-volatile memory 2534. The processor 2520 may include a main processor 2521 (e.g., a central processing unit (CPU) or an application processor (AP)), and an auxiliary processor 2523 (e.g., a graphics processing unit (GPU), an image signal processor (ISP), a sensor hub processor, or a communication processor (CP)) that is operable independently from, or in conjunction with, the main processor 2521. Additionally or alternatively, the auxiliary processor 2523 may be adapted to consume less power than the main processor 2521, or execute a particular function. The auxiliary processor 2523 may be implemented as being separate from, or a part of, the main processor 2521.

The auxiliary processor 2523 may control at least some of the functions or states related to at least one component (e.g., the display device 2560, the sensor module 2576, or the communication module 2590) among the components of the electronic device 2501, instead of the main processor 2521 while the main processor 2521 is in an inactive (e.g., sleep) state, or together with the main processor 2521 while the main processor 2521 is in an active state (e.g., executing an application). The auxiliary processor 2523 (e.g., an image signal processor or a communication processor) may be implemented as part of another component (e.g., the camera module 2580 or the communication module 2590) functionally related to the auxiliary processor 2523.

The memory 2530 may store various data used by at least one component (e.g., the processor 2520 or the sensor module 2576) of the electronic device 2501. The various data may include, for example, software (e.g., the program 2540) and input data or output data for a command related thereto. The memory 2530 may include the volatile memory 2532 or the non-volatile memory 2534. Non-volatile memory 2534 may include internal memory 2536 and/or external memory 2538.

The program 2540 may be stored in the memory 2530 as software, and may include, for example, an operating system (OS) 2542, middleware 2544, or an application 2546.

The input device 2550 may receive a command or data to be used by another component (e.g., the processor 2520) of the electronic device 2501, from the outside (e.g., a user) of the electronic device 2501. The input device 2550 may include, for example, a microphone, a mouse, or a keyboard.

The sound output device 2555 may output sound signals to the outside of the electronic device 2501. The sound output device 2555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 2560 may visually provide information to the outside (e.g., a user) of the electronic device 2501. The display device 2560 may include, for example, a display, a hologram device, or a projector and control circuitry to control a corresponding one of the display, hologram device, and projector. The display device 2560 may include touch circuitry adapted to detect a touch, or sensor circuitry (e.g., a pressure sensor) adapted to measure the intensity of force incurred by the touch.

The audio module 2570 may convert a sound into an electrical signal and vice versa. The audio module 2570 may obtain the sound via the input device 2550 or output the sound via the sound output device 2555 or a headphone of an external electronic device 2502 directly (e.g., wired) or wirelessly coupled with the electronic device 2501.

The sensor module 2576 may detect an operational state (e.g., power or temperature) of the electronic device 2501 or an environmental state (e.g., a state of a user) external to the electronic device 2501, and then generate an electrical signal or data value corresponding to the detected state. The sensor module 2576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 2577 may support one or more specified protocols to be used for the electronic device 2501 to be coupled with the external electronic device 2502 directly (e.g., wired) or wirelessly. The interface 2577 may include, for example, a high-definition multimedia interface (HDMI), a universal serial bus (USB) interface, a secure digital (SD) card interface, or an audio interface.

A connecting terminal 2578 may include a connector via which the electronic device 2501 may be physically connected with the external electronic device 2502. The connecting terminal 2578 may include, for example, an HDMI connector, a USB connector, an SD card connector, or an audio connector (e.g., a headphone connector).

The haptic module 2579 may convert an electrical signal into a mechanical stimulus (e.g., a vibration or a movement) or an electrical stimulus which may be recognized by a user via tactile sensation or kinesthetic sensation. The haptic module 2579 may include, for example, a motor, a piezoelectric element, or an electrical stimulator.

The camera module 2580 may capture a still image or moving images. The camera module 2580 may include one or more lenses, image sensors, image signal processors, or flashes. The power management module 2588 may manage power supplied to the electronic device 2501. The power management module 2588 may be implemented as at least part of, for example, a power management integrated circuit (PMIC).

The battery 2589 may supply power to at least one component of the electronic device 2501. The battery 2589 may include, for example, a primary cell which is not rechargeable, a secondary cell which is rechargeable, or a fuel cell.

The communication module 2590 may support establishing a direct (e.g., wired) communication channel or a wireless communication channel between the electronic device 2501 and the external electronic device (e.g., the electronic device 2502, the electronic device 2504, or the server 2508) and performing communication via the established communication channel. The communication module 2590 may include one or more communication processors that are operable independently from the processor 2520 (e.g., the AP) and supports a direct (e.g., wired) communication or a wireless communication. The communication module 2590 may include a wireless communication module 2592 (e.g., a cellular communication module, a short-range wireless communication module, and/or a satellite or GNSS communication module) or a wired communication module 2594 (e.g., a local area network (LAN) communication module or a power line communication (PLC) module). A corresponding one of these communication modules may communicate with the external electronic device via the first network 2598 (e.g., a short-range communication network, such as BLUETOOTH™, wireless-fidelity (Wi-Fi) direct, or a standard of the Infrared Data Association (IrDA)) or the second network 2599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 2592 may identify and authenticate the electronic device 2501 in a communication network, such as the first network 2598 or the second network 2599, using subscriber information (e.g., international mobile subscriber identity (IMSI)) stored in the subscriber identification module 2596.

The antenna module 2597 may transmit or receive a signal or power to or from the outside (e.g., the external electronic device) of the electronic device 2501. The antenna module 2597 may include one or more antennas, and, therefrom, at least one antenna appropriate for a communication scheme used in the communication network, such as the first network 2598 or the second network 2599, may be selected, for example, by the communication module 2590 (e.g., the wireless communication module 2592). The signal or the power may then be transmitted or received between the communication module 2590 and the external electronic device via the selected at least one antenna.

Commands or data may be transmitted or received between the electronic device 2501 and the external electronic device 2504 via the server 2508 coupled with the second network 2599. Each of the electronic devices 2502 and 2504 may be a device of a same type as, or a different type, from the electronic device 2501. All or some of operations to be executed at the electronic device 2501 may be executed at one or more of the external electronic devices 2502, 2504, or 2508. For example, if the electronic device 2501 should perform a function or a service automatically, or in response to a request from a user or another device, the electronic device 2501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 2501. The electronic device 2501 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
loading data from a memory to an input sample memory (ISM) of a user equipment (UE), wherein the data corresponds to input from an L5 antenna of the UE;
performing, by a first high-resolution correlation (HRC) engine of the UE, coherent correlation and accumulation on the data for at least one code-frequency offset combination, to generate coherent correlation results; and
processing, by a second HRC engine of the UE, the coherent correlation results by at least performing frequency widening and non-coherent accumulation to generate non-coherent correlation results indicating at least peak accumulations of correlations.

2. The method of claim 1, further comprising:
processing, by a front end processor (FEP) of the UE, the input from the L5 antenna after conversion into a digital data stream; and
saving the processed data at the memory, wherein the memory comprises an external double data rate (DDR) memory.

3. The method of claim 1, wherein:
the at least one code-frequency offset combination comprises a plurality of offset combinations;
the coherent correlation and accumulation is sequentially performed on the data for each offset combination to generate coherent correlation results for each offset combination; and
the coherent correlation results are processed sequentially for each offset combination.

4. The method of claim 3, further comprising:
storing each of the coherent correlation results at a coherent integration time (CIT) memory of the UE, wherein one of a first region and a second region of the CIT memory is used for data storage by the first HRC engine while another of the first region and the second region is accessed for data retrieval by the second HRC engine in a ping-pong manner.

5. The method of claim 4, wherein each of the first region and the second comprises four CIT regions, and each CIT region comprises 320 correlator taps.

6. The method of claim 4, wherein processing the coherent correlation results comprises, for each offset combination:
performing fast Fourier transform (FFT) on the coherent correlation results to widen a frequency range covered by a respective code-frequency offset;
selecting a number of center frequencies from the widened frequency range for the respective code-frequency offset; and
performing non-coherent accumulation on the FFT coherent correlation results, with respect to the number of center frequencies, to increase an accumulation time and generate the non-coherent correlation results.

7. The method of claim 4, wherein the data comprises 1 millisecond (ms) of data and the ISM comprises a 3 ms circular ISM, or the data comprises 4 ms of data and the ISM comprises a 10 ms circular ISM.

8. The method of claim 7, wherein:
the data comprises the 1 ms of data for strong signal acquisition followed by 4 ms of data for Neumann Hoffman (NH) synchronization and 4 ms of data for weak signal acquisition; or
the data comprises the 1 ms of data for strong signal acquisition or the 4 ms of data for weak signal acquisition with a known NH code alignment.

9. The method of claim 1, wherein the at least one code-frequency offset combination comprises a single offset combination, and further comprising:
storing the coherent correlation results across four CIT regions of a CIT memory of the UE, wherein each CIT region comprises 320 correlator taps.

10. The method of claim 9, wherein processing the coherent correlation results comprises, for each of a plurality of NH code alignments:
performing fast Fourier transform (FFT) on the coherent correlation results to widen a frequency range covered by a respective code-frequency offset;
selecting a number of center frequencies from the widened frequency range for the respective code-frequency offset; and
performing non-coherent accumulation on the FFT coherent correlation results, with respect to the number of center frequencies, to increase an accumulation time and generate the non-coherent correlation results.

11. The method of claim 9, wherein the data comprises 4 ms of data, and the ISM comprises a 10 ms circular ISM.

12. The method of claim 1, wherein:
the coherent correlation results comprise code-frequency offsets with peak accumulations of correlations over time; and
the non-coherent correlation results comprise code-frequency offsets with peak accumulations of correlations, and code-frequency offset regions of the peak accumulations.

13. The method of claim 1, further comprising:
storing the non-coherent correlation results in a digital signal processing (DSP) random access memory (RAM) of the UE; and
determining a code offset and a frequency offset for the input based on the non-coherent correlation results.

14. A user equipment (UE) comprising:
an input sample memory (ISM) configured to store data from a memory, wherein the data corresponds to input from an L5 antenna of the UE;
a first high-resolution correlation (HRC) engine configured to perform coherent correlation and accumulation on the data for at least one code-frequency offset combination, to generate coherent correlation results; and
a second HRC engine configured to process the coherent correlation results by at least performing frequency widening and non-coherent accumulation to generate non-coherent correlation results indicating at least peak accumulations of correlations.

15. The UE of claim 14, further comprising:
a front end processor (FEP) configured to process the input from the L5 antenna after conversion into a digital data stream,
wherein the processed data is saved at the memory, and the memory comprises an external double data rate (DDR) memory.

16. The UE of claim 14, wherein:
the at least one code-frequency offset combination comprises a plurality of offset combinations;
the coherent correlation and accumulation is sequentially performed on the data for each offset combination to generate coherent correlation results for each offset combination; and
the coherent correlation results are processed sequentially for each offset combination.

17. The UE of claim 16, further comprising:
a coherent integration time (CIT) memory configured to store each of the coherent correlation results, wherein one of a first region and a second region of the CIT memory is used for data storage by the first HRC engine while another of the first region and the second region is accessed for data retrieval by the second HRC engine in a ping-pong manner,
wherein processing the coherent correlation results comprises, for each offset combination:
performing fast Fourier transform (FFT) on the coherent correlation results to widen a frequency range covered by a respective code-frequency offset;
selecting a number of center frequencies from the widened frequency range for the respective code-frequency offset; and
performing non-coherent accumulation on the FFT coherent correlation results, with respect to the number of center frequencies, to increase an accumulation time and generate the non-coherent correlation results.

18. The UE of claim 14, wherein the at least one code-frequency offset combination comprises a single offset combination, and further comprising:
storing the coherent correlation results across four CIT regions of a CIT memory of the UE, wherein each CIT region comprises 320 correlator taps,
wherein processing the coherent correlation results comprises, for each of a plurality of Neumann Hoffman (NH) code alignments:
performing fast Fourier transform (FFT) on the coherent correlation results to widen a frequency range covered by a respective code-frequency offset;
selecting a number of center frequencies from the widened frequency range for the respective code-frequency offset; and
performing non-coherent accumulation on the FFT coherent correlation results, with respect to the number of center frequencies, to increase an accumulation time and generate the non-coherent correlation results.

19. The UE of claim 14, wherein the coherent correlation results comprise code-frequency offsets with peak accumulations of correlations over time, and the non-coherent correlation results comprise code-frequency offsets with peak accumulations of correlations, and code-frequency offset regions of the peak accumulations.

20. A user equipment (UE) comprising:
a processor; and
a non-transitory computer readable storage medium storing instructions that, when executed, cause the processor to:
load data from a memory to an input sample memory (ISM) of the UE, wherein the data corresponds to input from an L5 antenna of the UE;
perform, by a first high-resolution correlation (HRC) engine of the UE, coherent correlation and accumulation on the data for at least one code-frequency offset combination, to generate coherent correlation results; and
process, by a second HRC engine of the UE, the coherent correlation results by at least performing frequency widening and non-coherent accumulation to generate non-coherent correlation results indicating at least peak accumulations of correlations.
